(19) United States
(12) Patent Application Publication
(10) Pub. No.: US 2024/0292776 A1
(43) Pub. Date: Sep. 5, 2024

(54) SEED UNIT COMPRISING CHARCOAL AND POLYMERIC SUPERABSORBENT

(71) Applicant: Schierbecker Handels GmbH & Co. KG, Felde (DE)

(72) Inventor: Torben Schierbecker, Felde (DE)

(73) Assignee: Schierbecker Handels GmbH & Co. KG, Felde (DE)

(21) Appl. No.: 18/574,889

(22) PCT Filed: Jun. 30, 2022
(86) PCT No.: PCT/EP2022/068107

§ 371 Date: Dec. 28, 2023

(30) Foreign Application Priority Data
Jun. 30, 2021 (DE) 10 2021 116 842.2
Feb. 22, 2022 (DE) 10 2022 104 125.5

(51) Int. Cl. A01C 1/06

(52) U.S. Cl. CPC A01C 1/06

(57) ABSTRACT

The invention relates to a seed unit (1) which has at least one seed (2), a layer (3), for example made of biochar, and a polymeric superabsorbent (5), as for example a crosslinked acrylamide/acrylic acid copolymer, potassium salt, and optionally one shell (9) and other auxiliary materials, the polymeric superabsorbent (5) optionally having a grain size of 50 μm-400 μm and serving not only as a water storage, but also as an disintegrating-element.

The invention relates to a seed unit (1), comprising at least one seed (2), a layer (3), for example made of biochar, and a polymeric superabsorbent (5), such as a cross-linked acrylamide/acrylic acid copolymer potassium salt, and optionally a shell (9) and further auxiliary materials, wherein the polymeric superabsorbent (5) optionally having a grain size of 50 μm-400 μm and serving not only as a water storage but also as an disentegrant element.

Agriculture is already directly affected by climate change. The predicted shift in precipitation to winter and long dry summers were particularly evident in 2018. In addition, extreme weather events such as heavy rain, storms and floods are increasing. Another phenomenon that receives little attention is the absence of cold waves. However, this is of great importance for agriculture in the middle latitudes: pests or their larvae are no longer exposed to severe frost in winter, so more of them survive.

In addition, the EU Commission is reducing the number of approved herbicides, insecticides and fungicides by letting their approvals expire, not approving any new products and limiting the use of approved products. Their goal is to better protect both people and the environment from the poisons used. At the same time, however, conventional agriculture lacks alternatives to protect its crops, which means that exemptions are repeatedly issued to protect farmers from crop failures.

Also affected by bans and exemptions is seed pilling with corresponding neonicotinoids. During pilling, the seeds are covered with various substances (coating) before sowing. This has various advantages:
1. Homogenization of the seeds. This means that the seeds can be sown more easily and precisely by machine, so that the optimal seeding rate of the grains per m2 is achieved
2. The pilling mass contains crop protection products adapted to the crop. These are applied very specifically and only in small quantities. In addition, the pilling protects the plant particularly well in a particularly critical phase of growth—germination.
3. Plant-specific nutrients can be added to the pilling mass. Here too, the addition is particularly targeted.

In view of the major challenges in agriculture, a method such as pelleting makes sense because it specifically fights weaknesses in the respective crops and thus contributes to food security. In addition, it only applies the pesticides where they are needed, which significantly reduces the consumption of the corresponding substances. Accordingly, further development of pilling or pelletizing is desirable in order to better prepare agriculture for the challenges of the 21^{st} century.

The use of coal and/or polyacrylates in connection with seeds has been described variously in the prior art

CN109168409A, for example, describes a seed lubricant in which biochar is mixed with, among other things, a humectant made from potassium and sodium acrylate. However, the humectant made from potassium and sodium acrylate is ground very finely (“1000 to 1500 meshes”) and therefore cannot serve as a disintegrating element.

JPH09248017A describes a coated rice seed in which, for example, polyacrylic resin is applied to the seed surface and, for example, activated carbon powder is added. However, the polyacrylate resin is used for caking/gluing and not in particulate form.

DE 699 05 889 T2 (the German translation of European patent EP 1 091 641 B1) describes a substrate additive as pourable granules with a grain size of 0.3 to 3.0 mm for use in germination units. The substrate additive includes various substances, including superabsorbent polymers (SAP, with Stockosorb® being used in the examples), as well as fillers such as vermiculite, wood fibers or mineral fibers, with polyethylene glycol and polyvinyl alcohol being mentioned as binders. However, no pellet is formed around the seed and the superabsorbent polymer is placed directly into the soil and only serves as a water storage and not (also) as a disintegrating element.

EP 373 348 A1 describes a substrate additive containing a porous ion exchange material and a porous mineral additive, as well as charcoal/activated carbon and polyacrylamide. However, again no pellet is formed around the seed and the polyacrylamide is introduced to the plant root and only serves as a water storage and not (also) as a disintegrating element

WO2004/036975 A1 describes a method for producing a pellet in which peat was mixed with, for example, an insecticide and in which a seed is introduced through a hole into the dried mixture. Apart from the fact that, unlike biochar, the peat has an acidic pH, no superabsorbent is used here.

EP 2680685 B1 describes a composition for coating a seed, the seed being at least partially surrounded by a layer of guar or derivatized guar.

As can be seen from the prior art cited above, there is still a need for a seed unit consisting of a seed and with an advantageous and adaptable layer surrounding it as a result of pilling or pelleting in order to fight the weaknesses of the respective cultures in a very targeted manner.

### SUMMARY AND DEFINITIONS

Accordingly, one of the objects of the present invention is a seed unit comprising at least one seed, a “layer”, a polymeric superabsorbent and an adhesive of biological origin, as well as optionally a shell and further auxiliary materials, the layer at least partially (in particular completely) enclosing the seed, and wherein
the “layer” comprises the adhesive of biological origin and the polymeric superabsorbent; and
the “layer” comprises coal,
wherein the “layer” preferably consists of at least 50% by weight of coal.

The polymeric superabsorbent preferably has a grain size of 50 μm-400 μm, especially if the polymeric superabsorbent is a polyacrylamide, a crosslinked arylamide/acrylic acid, a polyacrylate or an acrylamide/acrylic acid copolymer.

Compared to the prior art, this seed unit has the advantage that—particularly if the seed unit takes the form of a pellet or a pill, or since the layer at least partially and in particular completely encloses the seed—the combination with the polymeric superabsorbent breaks up this layer/that pellet/this pill to make it easier for the seed/seedling to spread after the seed unit has been planted. The surprising germination success of the seed unit according to the invention is probably based on the fact that the polymeric superabsorbent, which was only taken into account as a water storage in the state of the art, can expand enormously when water is absorbed and can therefore break up the layer/pellet/pill. However, it seems that the polymeric superabsorbent should possibly have a certain grain size that should not be too large or too small in order to achieve this effect.

Experiments show that there are particularly favorable ranges of physical dimensions, such as size, etc., with regard to the material from which the layer is made (especially with regard to the coal and the polymer superabsorbent). On the one hand, these dimensions, in particular with regard to the polymeric superabsorbent, as described above, allow it to break up the layer/pellet/pill of the seed unit when it absorbs water due to its expansion and thus facilitates germination. The dimension (e.g. the grain size) should not be too small, otherwise the expansion (due to swelling) of the polymeric superabsorbent may no longer be sufficient to break up the layer etc. in the seed unit. On the other hand, the dimension/grain size of the material of the layer (particularly the coal and the polymer superabsorbent) should not be chosen too small so that the layer around the seed (especially if it consists of several sub-layers built on top of each other) does not become too firm and thus make it difficult to break up. The dimension (e.g. the grain size) of the material should not be too large, otherwise an even coating of the seed, especially with several thinner sub-layers, becomes more difficult purely due to the dimensions of the material.

Accordingly, the material of the layer (in particular the polymeric superabsorbent and the coal, preferably selected from activated carbon, biological coal and/or biochar, with the adhesive of biological origin, etc.) could have a dimension (such as a grain size; in particular as a diameter (in particular in the case of a rather spherical shape of the grain) or possibly also maximum axis length (especially if the seed unit has a rather elliptical shape)) of 30 μm-220 μm, or from 40 μm-220, or from 30 μm-180 μm, or from 50 μm-200 μm, or from 50 μm-150 μm or from 80 μm-120 μm to achieve good results.

In relation to the dimension of the seed unit (for example to its diameter), there is a relationship to the dimension of the layer material (for example to its diameter, in particular the coal and the polymer superabsorbent). A respective preferred ratio of the diameter of the seed unit to the diameter of the materials of the layer, in particular the coal and the polymeric superabsorbent, is, for example, from 650:1 to 10:1, or from 500:1 to 20:1, or from 400:1 to 30:1, from 300:1 to 40:1, or from 200:1 to 50:1. In particular, the diameter of the materials of the layer (3), in particular the coal and the polymeric superabsorbent (5), should be viewed as synonymous with their grain size.

Accordingly, the material of the layer (in particular the polymeric superabsorbent and the coal, preferably selected from activated carbon, biological coal and/or biochar, with the adhesive of biological origin etc.) could show one dimension/one grain size
from 30 μm-180 μm, with a ratio of the diameter of the seed unit to the grain size of the materials of the layer of, for example, 200:1 to 50:1;
from 50 μm-150 μm, with a ratio of the diameter of the seed unit to the grain size of the materials of the layer of 300:1 to 40:1, or in particular from 200:1 to 50:1;
from 80 μm-120 μm, with a ratio of the diameter of the seed unit to the grain size of the materials of the layer of 400:1 to 30:1, or from 300:1 to 40:1, or in particular from 200:1 to 50:1.

Particularly preferred is a seed unit in the form of a pellet comprising at least one seed, a layer, a polymeric superabsorbent and an adhesive of biological origin, as well as optionally a shell and further auxiliary materials, wherein the layer at least partially encloses the seed, characterized in that
the polymeric superabsorbent is selected
   a. a polyacrylamide, a crosslinked arylamide/acrylic acid, a polyacrylate or an acrylamide/acrylic acid copolymer, or
   b. a biological polymeric superabsorbent selected from a cellulose or lignin-based hydrogel or a natural rubber derivative;
the layer comprises coal, selected from activated carbon, biological coal or biochar, and consists of at least 50% by weight of the coal, selected from activated carbon, biological coal or biochar,
the layer comprises the adhesive of biological origin and the polymeric superabsorbent.

Particularly preferred is a seed unit in the form of a pellet comprising at least one seed, a layer, a polymeric superabsorbent and an adhesive of biological origin, as well as optionally a shell and further auxiliary materials, wherein the layer at least partially encloses the seed, characterized in that
the polymeric superabsorbent is a polyacrylamide, a cross-linked arylamide/acrylic acid, a polyacrylate or an acrylamide/acrylic acid copolymer,
the layer comprises coal, selected from activated carbon, biological coal or biochar, and consists of at least 50% by weight of the coal, selected from activated carbon, biological coal or biochar,
the layer comprises the adhesive of biological origin and the polymeric superabsorbent and
the polymeric superabsorbent has a grain size of 50 μm-400 μm.

The term “seed unit” in the sense of the invention is a unit that comprises a seed and a “layer” that at least partially surrounds it, preferably consists of a seed and a layer that at least partially surrounds it. Preferably the seed unit takes the form of a pellet or pill. Also preferably, the “layer” completely envelops the seed (2) and/or the “layer” and the seed are/form the pellet/pill. The seed unit is in particular adapted to the standard size for commercially available seed drills, so that the seed unit has, for example, a diameter (particularly if the seed unit has a more spherical shape) or a maximum axis length (if the seed unit has a more elliptical shape) of 2 mm to 20 mm, from 3 mm to 15 mm, from 5 mm to 20 mm or from 3 mm to 10 mm. In particular, the layer can surround the seed in the form of at least one, preferably several partial layers—at least partially, preferably completely. The layer can in this be applied to the seed in several partial layers. These partial layers are preferably applied in a thickness of 0.1 to 5 mm, or 0.5 to 3 mm, or 0.5 mm, 1 mm, 2 mm, 3 mm, 4 mm or 5 mm, so that—depending on choice—for example seed units with a diameter (especially if the seed unit has a more spherical shape) or possibly a maximum axis length (especially if the seed unit has a more elliptical shape) of 2 mm to 20 mm, from 3 mm to 15 mm, from 5 mm to 20 mm or from 3 mm to 10 mm or also from 5 mm to 10 mm. In particular, this allows sufficient material to be distributed around the seed to achieve good results.

The term “pellet” or “pill” in the sense of the invention is a form of the “seed unit” in which the “layer” at least partially or (at least almost) completely envelops the “seed” so that the “layer” and the “seed”, if appropriate with a “shell”, are/form the pellet/pill. In this, the mass that makes up the “layer” is applied to the seed using a pelletizing or pilling process. The pellet/pill usually has a round or elliptical shape. Pellet and pill are used interchangeably in this text.

The term “seed” in the sense of the invention refers in principle to any type of seeds and in particular includes the individual unit of such seeds. In particular, small-grain seeds (<3.5 mm) benefit from the seed unit according to the invention (pelleting/pilling), as they can thereby be adapted to the above-mentioned standard size for commercially available seed drills. The “seed” is preferably selected from seeds for carrots, salads, tomatoes, sugar beet, fodder beet, rapeseed, camelina, flax, brassicas, beetroot, radish, parsnip, celery, parsley, chives, or for medicinal herbs such as valerian, thyme, oregano, ribwort plantain, or coneflower.

The term “layer” in the sense of the invention refers to a mass or matrix that at least partially, in particular completely, envelops the seed, for example as a result of an—optional multiple-pelletizing or pilling process (optionally in several sub-layers), which contains a polymeric superabsorbent and an adhesive of biological origin and possibly other auxiliary substances. The/a main component of the layer is, for example, coal (which can form a matrix), wherein this carbin, preferably being selected from activated carbon, biological coal and/or biochar. The “layer” preferably contains 5-30% by weight or 10-20% by weight of a polymeric superabsorbent. The “layer” can preferably also contain 1-15% by weight of adhesive of biological origin, 5-30 or 10-20% by weight of polymeric superabsorbent and 55-94% by weight of coal. The “layer” can in particular also contain 1-15% by weight of adhesive of biological origin, 5-30 or 10-20% by weight of polymeric superabsorbent, 1-20 or 5-15% by weight of nutrients or nutrient elements (if present), 1-10% by weight of repellent and/or anti-feeding elements (if present), 0.001-1% by weight of strengthening agent or strengthening elements (if present), with the rest of the “layer” consisting of coal. Optionally, the “layer” can be surrounded by a shell. It is also preferred if the “layer” contains at least 50% by weight, at least 75% by weight, at least 90% by weight, at least 94% by weight or at least 95% by weight of coal. Preferably, the superabsorbent and any additional auxiliary materials are embedded in the “layer”—in particular as particles- and/or the adhesive of biological origin is distributed approximately uniformly or homogeneously in the “layer” and in particular in the coal. In particular, the layer can surround the seed in the form of at least one, preferably several partial layers—at least partially, preferably completely. In this, the layer can be applied to the seed in several partial layers. These partial layers are preferably applied in a thickness of 0.1 to 5 mm, or 0.5 to 3 mm, or 0.5 mm, 1 mm, 2 mm, 3 mm, 4 mm or 5 mm, so that—depending on choice—for example seed units from 2 mm to 20 mm, from 3 mm to 15 mm, from 5 mm to 20 mm or from 3 mm to 10 mm or from 5 mm to 10 mm. In particular, this allows sufficient material to be distributed around the seed in the “layer” to achieve good results. Preferably, the material of the layer (in particular the polymeric superabsorbent and the coal, preferably selected from activated carbon, biological coal and/or biochar, with the adhesive of biological origin, etc.) can have a grain size of 30 μm-180, 50 μm-200 μm, or from 50 μm-150 μm or from 80 μm-120 μm.

The term “coal” in the sense of the invention refers in principle to any type of coal, with activated carbon, charcoal, biological coal or biochar being particularly preferred. A pyrolytically produced biochar is particularly preferred. One example is biochar from HerCarbo, for example made from herbs or forest wood chips. It is particularly preferred if the coal is preferably ground and/or if the grain size of the coal is <150 μm, <200 μm, <250 μm or <300 μm, in particular <200 μm. It is also particularly preferred if the grain size of the coal is <150 μm, <200 μm, <250 μm or <300 μm, in particular <200 μm or or 30 μm-200 μm, 40 μm-200 μm, 30 μm-180 μm or 50 μm-150 μm, or 80 μm-120 μm. It is also preferred if the coal in the “layer” is at least 50% by weight, at least 75% by weight, at least 90% by weight, at least 95% by weight, at least 99% by weight. -% or 100% by weight of activated carbon, biochar and/or biological coal, preferably activated carbon or biochar, in particular pyrolytically produced biochar. In particular—thanks to its composition—biochar, for example, contains trace elements that are immediately—in terms of time and space—available to the seedling emerging from the seed.

The basis of the seed unit according to the invention and in particular of the mass of which the “layer” consists should in particular be formed by pyrolytically produced biochar. Biochar has two important properties. It has a very large surface area that can absorb nutrients and water and serves as a habitat for microorganisms. In this way, it protects the seedling from dry periods, reduces the requirements for additional soil irrigation and creates ideal growing conditions. In addition, its structure is stable for several decades. Since it consists of over 90% coal, this is permanently removed from the atmosphere.

The term “polymeric superabsorbent” in the sense of the invention is defined as a polymer that is capable of absorbing polar liquids many times its own weight. Examples are mineral or starch-based polyacrylates. The “polymeric superabsorbent” preferably serves as a water storage- and disintegrating element, and/or is solid or crystalline or at the same time solid and crystalline, and/or is ground and/or has a grain size of 100 μm-350 μm or 150 μm-300 μm or from 175 μm-225 μm. The “polymeric superabsorbent” can also have a grain size of 30 μm-180, 50 μm-200 μm, or 50 μm-150 μm or 80 μm-120 μm. The superabsorbent is preferably embedded in the “layer”—in particular as particles- and/or contained in the “layer” at 5-30% by weight or 10-20% by weight. Preferably, the “polymeric absorbent” is a polyacrylamide or a cross-linked arylamide/acrylic acid, a polyacrylate, an acrylamide/acrylic acid copolymer, which may optionally be cross-linked, or mixtures thereof. Particularly preferably, the “polymeric absorbent” is a sodium polyacrylate or potassium polyacrylate or an acrylamide/acrylic acid copolymer potassium or sodium salt or a cross-linked acrylamide/acrylic acid copolymer potassium or sodium salt, a crosslinked arylamide/acrylic acid in the form of a potassium or sodium salt or mixtures thereof. Particularly preferably, the “polymeric absorbent” is a potassium polyacrylate or acrylamide/acrylic acid copolymer potassium salt or a cross-linked acrylamide/acrylic acid copolymer potassium salt or a crosslinked arylamide/acrylic acid in the form of a potassium salt or mixtures thereof. A particularly preferred example is Stockosorb®. Alternatively, the “polymeric superabsorbent” is a biological polymeric superabsorbent selected from a cellulose or lignin-based hydrogel or a natural rubber derivative, preferably selected from a cellulose or lignin-based hydrogel. A particularly preferred example is Polyter GT or Agrobiogel.

The term “adhesive of biological origin” in the sense of the invention is defined as any form of binding material of biological origin that binds the components of the “layer” such as the coal/biochar and integrates it with the polymeric superabsorbent and, if appropriate, the auxiliary materials in the “layer” whereby the “layer” is also connected to (or around) the seed—for example in the case of a pellet. The adhesive of biological origin is preferably a protein—containing glue, in particular a glutin-based glue, a fibrin-based glue, a glue based on the amino acid DPPA or a fish glue. The adhesive of biological origin is particularly preferably fish glue from cold water fish. The adhesive of biological origin may also contain additives such as gum arabic or protein hydrolyzate. Preferably, the adhesive of biological origin is distributed approximately evenly or homogeneously in the “layer” and in particular in the coal. The “layer” may preferably contain 1-15% by weight of adhesive of biological origin.

The term “shell” in the sense of the invention is defined as a solid filling around the seed unit, wherein the shell preferably (almost) completely encloses the layer. The shell preferably consists of gelatin, cellulose, carrageenan, starch or glue.

The term “auxiliary substances” in the sense of the invention is defined as substances that are immediately available—in terms of time and space—to the seedling emerging from the seed and offer additional biostimulants to ensure a high germination and growth rate. In particular, the auxiliary substances include nutrients or nutrient elements, repellents or anti-feeding elements and strengthening agents or strengthening elements. The auxiliary substances are preferably embedded in the “layer”, in particular the auxiliary substances are embedded in the “layer” as particles. The “layer” may preferably contain 1-20 or 5-15% by weight of nutrients or nutrient elements (if any), 1-10% by weight of repellents and/or anti-feeding elements (if any) and 0.001-1% by weight. % strengthening agent or strengthening elements (if any) included.

The term “nutrients or nutrient elements” in the sense of the invention is defined as macro- and micronutrients that are immediately—in terms of time and space—available to the seedling emerging from the seed. These are preferably fertilizers, for example protein-based fertilizers such as vinasse/stillage or protein hydrolysates. Preferably the nutrients or nutrient elements are organic based, wherein these are preferably protein-based fertilizers, preferably vinasse/stillage or protein hydrolysates. The “layer” may preferably contain 1-20 or 5-15% by weight of nutrients or nutrient elements (if any). The “nutrients or nutrient elements” are preferably embedded in the “layer”—in particular as particles.

In particular, the biochar will be “charged” with an organic fertilizer. This fertilizer is immediately—in terms of time and space—available to the seedling and offers additional biostimulants. This ensures a high germination and growth rate.

The term “repellent and/or anti-feeding elements” in the sense of the invention is defined as substances that immediately—in terms of time and space—protect the seedling emerging from the seed from damage by pests. In particular, the repellents and anti-feeding elements used according to the invention are based on aroma or extract, preferably on a plant and/or aroma extract basis, in particular on an ethereal plant and/or aroma extract basis. In particular, the repellents and anti-feeding elements used according to the invention are extracts from cayenne pepper, neem tree, ginger, oregano, geraniums (in particular from South African Capeland geranium), cistose herb or thyme. The repellent and anti-feeding elements used according to the invention (if present) are preferably embedded in the “layer”, with the repellent and/or anti-feeding elements (if present) being present in the “layer” at 1-10% by weight. The “repellent and/or anti-feeding elements” are preferably embedded in the “layer”—especially as particles.

It is a further object of the invention to add natural-based plant protection products to the seed unit (the pellet). The aim is not to kill the pests, but rather to specifically expel them using, for example, essential oils, which prevent the pest from damaging the seeds.

The term “strengthening agent or strengthening elements” in the sense of the invention is defined as agents that are intended to make the plant fit and also keep it healthy. For example, they can increase plants' frost resistance, optimize nutrient utilization and improve plant growth. A plant strengthening agent does not provide the plant with nutrients, nor does it control wild weeds or a parasite. However, once the plant is sick, plant strengthening agents cannot combat the disease. However, after overcoming the disease, plant strengthening agents can, in turn, help accelerate plant growth and regeneration. A preferred strengthening agent or strengthening element is a strengthening agent derived from pitch clove and lupine. Preferably, the strengthening agents or strengthening elements (if present) are present in the “layer” at 0.001-1% by weight. Preferably, the “strengthening agents or strengthening elements” are embedded in the “layer”—in particular as particles

A further subject of the present invention is a method for producing a seed unit according to the invention as discussed above, with the following steps:
STEP I:
Presenting the coal in ground form as part of the “layer”
   Mixing with a polymeric superabsorbent;
   optionally mixing with nutrients or nutrient elements and/or
   optionally mixing with strengthening agents or strengthening elements (8),
   wherein the optional mixing takes place before transfer to a mixing unit (A) or in the mixing unit (A).
grinding in a grinding apparatus (B);
optional STEP II:
optionally adding at least one type of repellent- and/or anti-feeding-element (7), preferably several different types of repellent- and/or anti-feeding-elements (7) previously mixed in a mixing unit,
to the ground mixture from step I in a mixing unit (D);
STEP III:
Adding the seed (2) and the adhesive of biological origin (3), optionally mixing them before addition, to the mixture from step Il in a pelletizing plant (E), the seed (2) forming the core around which pilling, or pelletizing occurs.

The term “mixing unit” in the sense of the invention is defined as an apparatus (see (A), (C), (D) in FIG. 3)), in which components of the seed unit according to the invention, in particular components of the “layer”, such as (matrix-forming) coal, the polymeric superabsorbent (possibly the adhesive of biological origin) and, if appropriate, other auxiliary materials are mixed together before grinding or pelletizing/pilling.

The term “grinding apparatus” in the sense of the invention is defined as an apparatus in which components of the seed unit according to the invention, in particular components of the “layer”, such as the (matrix-forming) coal, the polymeric superabsorbent, (possibly the adhesive of biological origin) and possibly others Auxiliary materials will be ground before any pelletizing or pilling.

The term “pilling plant in the sense of the invention is defined as an apparatus in which the seed unit according to the invention is formed into a pellet or a pill. In this, the seed forms the core around which—using the pelletizing/pilling process—a layer is formed from the components of the “layer”, such as the (matrix-forming) coal, the polymer superabsorbent and, if appropriate, other auxiliary materials with the help of the adhesive of biological origin thus forming the pellet/pill.

The term “pilled” or “pelletized” in the sense of the invention is defined as a process step in which the seed unit according to the invention is formed into a pellet or a pill in an apparatus (a pilling or pelletizing plant). The seed forms the core around which—using the pelletizing/pilling process—a layer is formed from the components of the “layer”, such as the (matrix-forming) coal, the polymer superabsorbent and, if appropriate, other auxiliary materials with the help of the adhesive of biological origin thus forming the pellet/pill.

Another object of the present invention is a seed unit covered by a “layer” of biochar, producible by a process comprising the following steps
STEP I:
Presenting the biochar in ground form as part of the layer (3),
mixing with a polymeric superabsorbent (5) containing ≥50% by weight of polyacrylate;
optionally mixing with nutrients or nutrient elements (6) and/or
optionally mixing with strengthening agents or strengthening elements (8),
wherein the optional mixing takes place before transfer to a mixing unit (A) or in the mixing unit (A).
grinding in a grinding apparatus (B);
optional STEP II:
Optionally adding at least one type of repellent- and/or anti-feeding-element (7), preferably several different types of repellent- and/or anti-feeding-elements (7) previously mixed in a mixing unit (C),
to the ground mixture from step I in a mixing unit (D);
STEP III:
Adding the seed (2) and the adhesive of biological origin (3), optionally mixing them before addition, to the mixture from step Il in a pelletizing plant (E), the seed (2) forming the core around which pilling, or pelletizing occurs.

### DESCRIPTION OF THE FIGURES

FIG. 1) shows schematically a seed unit (1) according to the invention in the form of a pellet with a seed (2), a layer (3) (made of coal with an adhesive of biological origin (4)), a polymeric superabsorbent (5), a shell (9), nutrients (6), repellents and antifeeding elements (7) and strengthening agents (8).

FIG. 2) shows in A a seed made from valerian seeds consisting of several seeds (2) and in C the seed unit according to the invention (1) obtained therefrom using the method according to the invention. The figure also shows in B a seed of raspberry seeds consisting of several seeds (2) and in D the seed unit according to the invention (1) obtained therefrom using the method according to the invention.

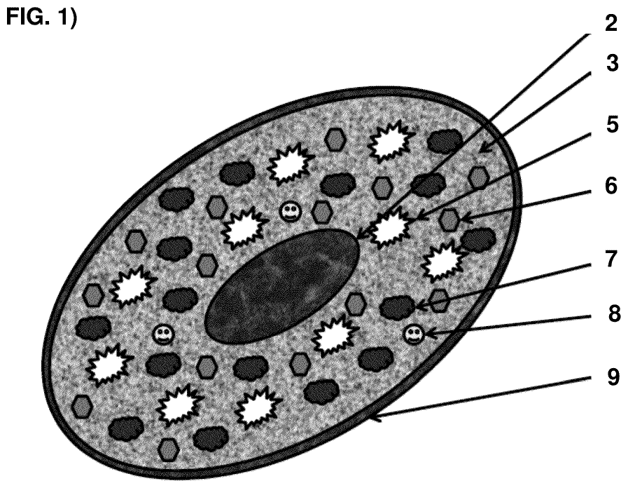

FIG. 3) shows schematically a method for producing a seed unit (1) according to the invention with the following steps:
STEP I:
Presenting the oarbon in ground form as part of the layer (3) already mixed with the polymeric superabsorbent (5);
Mixing with nutrients (6) and mixing with strengthening agents (8) in a mixing unit (A)
Grinding in a grinding apparatus (B);
STEP II:
Mixing (in this case three types of) repellents and anti.feeding elements (7) in a mixing unit (C) and adding them to the ground mixture from stage I in a mixing unit (D);
STEP III:
Adding the seed (2) and the adhesive of biological origin (4) to the mixture from step II in a pelletizing plant (E), the seed (2) forming the core around which pilling or pelletizing takes place, so that the Seed unit (1) is created.

In that, in FIG. 3, the following letters optionally represent the following information:

(a) Biochar 70% m/m+potassium polyacrylate 19.998% m/m
(b) Organic fertilizer 10% m/m
(c) Plant strengthening agent 0.002% m/m

### (d) Neem oil 15% m/m

(e) Cayenne pepper extract 4% m/m
(f) Thyme essential oil 1% m/m

### (g) Seeds

(h) pilling aid (binder)
(j) Mixing unit

### (k) Grinding

(m) Pilling plant.

### DETAILED DESCRIPTION

As said above, the main subject of the present invention is a seed unit (1) (in particular in the form of a pellet) comprising at least (in particular exactly) one seed (2), a layer (3), a polymeric superabsorbent (5) and an adhesive of biological origin (4), and optionally a shell (9) and other auxiliary materials, the layer (3) at least partially (in particular completely) enclosing the seed (2), whereby
the layer (3) comprises the adhesive of biological origin (4) and the polymeric superabsorbent (5); and
the layer (3) comprises coal (in particular activated carbon, biological coal or biochar),
wherein preferably the layer (3) consists of at least 50% by weight of coal (in particular activated carbon, biological coal or biochar).

In a preferred embodiment, the polymeric superabsorbent (5) has a grain size of 50 μm-400 μm, in particular if the polymeric superabsorbent (5) is a polyacrylamide, a crosslinked arylamide/acrylic acid, a polyacrylate or an acrylamide/acrylic acid copolymer.

In a preferred embodiment, the polymeric superabsorbent is granular or granulous or in the form of a grain, or is solid and crystalline, and optionally has in this form—in particular if the polymeric superabsorbent (5) is a polyacrylamide, a crosslinked arylamide/acrylic acid, a polyacrylate or an acrylamide/acrylic acid copolymer—corresponding to the grain size specified above of 50 μm-400 μm.

In a preferred embodiment of the seed unit (1) according to the invention, it is in the form of a pellet comprising at least one seed (2), a layer (3), a polymeric superabsorbent (5) and an adhesive of biological origin (4), and optionally a shell (9) and other auxiliary materials, the layer (3) at least partially enclosing the seed (2), characterized in that
the polymeric superabsorbent (5) is selected
   a. a polyacrylamide, a crosslinked arylamide/acrylic acid, a polyacrylate or an acrylamide/acrylic acid copolymer, or
   b. a biological polymeric superabsorbent selected from a cellulose- or lignin-based hydrogel or a natural rubber derivative;
the layer (3) comprises coal, selected from activated carbon, biological coal or biochar, and consists of at least 50% by weight of the coal, selected from activated carbon, biological coal or biochar, and
the layer (3) comprises the adhesive of biological origin (4) and the polymeric superabsorbent (5).

In a preferred embodiment of the seed unit (1) according to the invention, it is in the form of a pellet comprising at least one seed (2) and a layer (3) comprising coal, selected from activated carbon, biological coal or biochar, a polymeric superabsorbent (5) and an adhesive of biological origin (4); and optionally a shell (9) and further auxiliary materials, the layer (3) at least partially enclosing the seed (2), characterized in that
the polymeric superabsorbent (5) is selected from
   a. a polyacrylamide, a crosslinked arylamide/acrylic acid, a polyacrylate or an acrylamide/acrylic acid copolymer, or
   b. a biological polymeric superabsorbent selected from a cellulose- or lignin-based hydrogel or a natural rubber derivative;
the layer (3) consists of at least 50% by weight of coal, selected from activated carbon, biological coal or biochar.

Preferably, in the two directly preceding preferred embodiments, the polymeric superabsorbent is granular or granulous or in the form of a grain, or is solid and crystalline. In this form, the polymeric superabsorbent has a grain size of 50 μm-400 μm, especially if the polymeric superabsorbent (5) is a polyacrylamide, a crosslinked arylamide/acrylic acid, a polyacrylate or an acrylamide/acrylic acid copolymer.

In a particularly preferred embodiment of the seed unit (1) according to the invention, it is in the form of a pellet comprising at least one seed (2), a layer (3), a polymeric superabsorbent (5) and an adhesive of biological origin (4), and optionally a shell (9) and other auxiliary materials, the layer (3) at least partially enclosing the seed (2), characterized in that
the polymeric superabsorbent (5) is a polyacrylamide, a cross-linked arylamide/acrylic acid, a polyacrylate or an acrylamide/acrylic acid copolymer,
the layer (3) comprises coal, selected from activated carbon, biological coal or biochar, and consists of at least 50% by weight of the coal, selected from activated carbon, biological coal or biochar,
the layer (3) comprises the adhesive of biological origin (4) and the polymeric superabsorbent (5) and
the polymeric superabsorbent (5) has a grain size of 50 μm-400 μm.

In a likewise particularly preferred embodiment of the seed unit (1) according to the invention, it is in the form of a pellet comprising at least one seed (2) and a layer (3) comprising coal, selected from activated carbon, biological coal or biochar, a polymeric superabsorbent (5) and an adhesive of biological origin (4); and optionally a shell (9) and further auxiliary materials, the layer (3) at least partially enclosing the seed (2), characterized in that
the polymeric superabsorbent (5) is a polyacrylamide, a cross-linked arylamide/acrylic acid, a polyacrylate or an acrylamide/acrylic acid copolymer,
the layer (3) comprises coal, selected from activated carbon, biological coal or biochar, and consists of at least 50% by weight of the coal, selected from activated carbon, biological coal or biochar, and
the polymeric superabsorbent (5) has a grain size of 50 μm-400 μm.

Preferably, in the two immediately preceding preferred embodiments, the polymeric superabsorbent is granular or granulous or in the form of a grain, or is solid and crystalline, and the polymeric superabsorbent in this form correspondingly has the grain size specified above.

In a preferred embodiment of the seed unit (1) according to the invention, the coal in the layer (3) consists of at least 50% by weight, at least 75% by weight, at least 90% by weight and at least 95% by weight, or at least 99% by weight of activated carbon, biochar and/or biological coal, preferably activated carbon or biochar, whereby the coal is preferably ground, and/or wherein the grain size of the coal is <150 μm, <200 μm, <250 μm or <300 μm, in particular <200 μm. In a preferred embodiment of the seed unit (1) according to the invention, the coal in the layer (3) consists of at least 50% by weight, at least 75% by weight, at least 90% by weight, at least 95% by weight, or at least 99% by weight of activated carbon, biochar and/or biological coal, preferably activated carbon or biochar, the coal preferably being ground, and/or wherein the grain size of the coal is <150 μm, <200 μm, <250 μm or <300 μm, in particular <200 μm, or 30 μm-200 μm, 40 μm-200 μm, 30 μm-180 μm or 50 μm-150 μm, or 80 μm-120 μm.

In a preferred embodiment of the seed unit (1) according to the invention, the coal in the layer (3) consists of at least 60% by weight, at least 70% by weight, at least 95% by weight, or at least 99% by weight. % of biochar, wherein the biochar is preferably ground, and/or where the grain size of the biochar is <200 μm, 30 μm-200 μm, 40 μm-200 μm, 30 μm-180 μm, or 50μm-150 μm, or 80 μm-120 μm.

In a preferred embodiment of the seed unit (1) according to the invention, the adhesive of biological origin (4) is a protein-containing glue, preferably a glutin-based glue, a fibrin-based glue, or a glue based on the amino acid DPPA, or a fish glue, particularly preferably an fish glue from cold water fish, whereby the adhesive of biological origin can contain additives such as gum arabic or protein hydrolyzate.

In a preferred embodiment of the seed unit (1) according to the invention
the layer (3) completely encloses the seed (2); and or
the superabsorbent (5) and any (appropriate) additional auxiliary substances are embedded in the layer (3)—in particular as particles, and/or
the adhesive of biological origin (4) is distributed approximately uniformly or homogeneously in the layer (3) and in particular in the coal, and/or
if appropriate, the shell (9) completely encloses the layer (3).

In a preferred embodiment of the seed unit (1) according to the invention, the appropriate additional auxiliary substances are selected from:
nutrients or nutrient elements (6);
repellent- and/or anti-feeding elements (7); and or
strengthening agents or strengthening elements (8).

In a preferred embodiment of the seed unit (1) according to the invention
the polymeric superabsorbent (5) serves as a water storage- and disintegrating element, and/or
the polymeric superabsorbent (5) is solid or crystalline or solid and crystalline, and/or
the polymeric superabsorbent (5) is ground and/or
the polymeric superabsorbent (5) has a grain size of 50 μm-400 μm, 100 μm-350 μm or 150 μm-300 μm or 175 μm-225 μm.

In a preferred embodiment of the seed unit (1) according to the invention, the polymeric superabsorbent (5) is a polyacrylamide or a cross-linked arylamide/acrylic acid, a polyacrylate, an acrylamide/acrylic acid copolymer (optionally cross-linked) or mixtures thereof, preferably sodium polyacrylate or potassium polyacrylate or acrylamide/Acrylic acid copolymer potassium or sodium salt or a cross-linked acrylamide/acrylic acid copolymer potassium or sodium salt, a cross-linked arylamide/acrylic acid in the form of a potassium or sodium salt or mixtures thereof, particularly preferably potassium polyacrylate or acrylamide/acrylic acid copolymer potassium salt or a cross-linked acrylamide/acrylic acid copolymer potassium salt or a crosslinked arylamide/acrylic acid in the form of a potassium salt (for example Stockosorb®) or mixtures thereof. Alternatively, the “polymeric superabsorbent” is a biological polymeric superabsorbent selected from a cellulose- or lignin-based hydrogel or a natural rubber derivative, preferably selected from a cellulose- or lignin-based hydrogel. A particularly preferred example is Polyter GT or Agrobiogel. Overall, the polymeric superabsorbent (5) is characterized by the fact that it
serves as a water storage- and disintegrating element, and/or
is solid or crystalline or solid and crystalline, and/or
is ground and/or
has a grain size of 50 μm-400 μm or 100 μm-350 μm or 150 μm-300 μm or 175 μm-225 μm.

The polymeric superabsorbent (5) can also be characterized by having a grain size of 30 μm-180 μm, 50 μm-200 μm, or 50 μm-150 μm or 80 μm-120 μm.

In a preferred embodiment of the seed unit (1) according to the invention, the polymeric superabsorbent (5) is a polyacrylamide, a crosslinked arylamide/acrylic acid, a polyacrylate or an acrylamide/acrylic acid copolymer, in particular a sodium polyacrylate or potassium polyacrylate or acrylamide/acrylic acid copolymer potassium or sodium salt or a cross-linked acrylamide/acrylic acid copolymer potassium or sodium salt, a cross-linked arylamide/acrylic acid in the form of a potassium or sodium salt or mixtures thereof, particularly preferably potassium polyacrylate or acrylamide/acrylic acid copolymer potassium salt or a cross-linked acrylamide/acrylic acid copolymer potassium salt or a crosslinked arylamide/acrylic acid in the form of a potassium salt or mixtures thereof, wherein the polymeric superabsorbent (5)
serves as a water storage- and disintegrating element, and/or
is solid or crystalline or solid and crystalline, and/or
is ground and/or
has a grain size of 50 μm-400 μm, or 100 μm-350 μm or 150 μm-300 μm or 175 μm-225 μm, or a grain size of 30 μm-180 μm, 50 μm-200 μm, or from 50 μm-150 μm or from 80 μm-120 μm.

Preferably, in one of these two directly preceding preferred embodiments, the polymeric superabsorbent is granular or granulous or in the form of a grain, or is solid and crystalline and the polymeric superabsorbent in this form correspondingly has the grain size specified above.

In a preferred embodiment of the seed unit (1) according to the invention, a further auxiliary substance is nutrients or nutrient elements (6), which are included in the seed unit (1) and are preferably embedded in the layer (3), wherein the nutrients or nutrient elements (6) are preferably Macro- and micronutrients and/or nutrients or nutrient elements (6) organically based, wherein these are preferably protein-based fertilizers, preferably vinasse/stillage or protein hydrolysates.

In a preferred embodiment of the seed unit (1) according to the invention, a further auxiliary substance is repellent and/or anti-feeding elements (7), which are included in the seed unit (1) and are preferably embedded in the layer (3), wherein the repellent elements and/or anti-feeding elements (7) are preferably based on plant- and/or aromatic-extracts, optionally based on essential plant- and/or aromatic-extracts, in particular include extracts from cayenne pepper, neem tree, ginger, oregano, geraniums, cistose herb or thyme.

In a preferred embodiment of the seed unit (1) according to the invention, a further auxiliary substance is a strengthening agent or strengthening element (8), which are included in the seed unit (1) and are preferably embedded in the layer (3), the strengthening elements (8) preferably include organic fertilizers, preferably a strengthening active ingredient obtained from pitch clove and lupine.

In a preferred embodiment of the seed unit (1) according to the invention, the seed unit (1) also comprises a shell (9), wherein the shell (9) preferably completely encloses the layer (3), wherein the shell (9) is preferably made of gelatin, cellulose, carrageenan, starch or glue.

In a preferred embodiment of the seed unit (1) according to the invention, the seed (2) is a small-grain seed (2), in particular a seed (2) with a size <3.5 mm, preferably the seed (2) is selected from seeds for carrots, salads, tomatoes, sugar beet, fodder beet, rapeseed, camelina, flax, cabbage, beetroot, radish, parsnip, celery, parsley, chives, or medicinal herbs such as valerian, thyme, oregano, ribwort plantain, coneflower.

In a preferred embodiment of the seed unit (1) according to the invention
the layer (3) consists of 5-30% by weight or 10-20% by weight of the polymeric superabsorbent (5);
   preferably
the layer (3) consists of 1-15% by weight of the adhesive of biological origin (4);
the layer (3) consists of 5-30 (preferably 10-20) % by weight of the polymeric superabsorbent (5), and
the layer (3) consists of 55-94% by weight of coal;
   in particular
the layer (3) consists of 1-15% by weight of the adhesive of biological origin (4);
the layer (3) consists of 5-30 (preferably 10-20)% by weight of the polymeric superabsorbent (5), and/or
the layer (3) consists of 1-20 (preferably 5-15)% by weight of nutrients or nutrient elements (6), when optionally added,
the layer (3) consists of 1-10% by weight of repellent and/or anti-feeding elements (7), when optionally added,
the layer (3) consists of 0.001-1% by weight of strengthening agents or strengthening elements (8), when optionally added,
the rest of the layer (3) consists of coal.
is pilled around or pelletized.

In a preferred embodiment of the seed unit (1) according to the invention, the ratio of the diameter of the seed unit (1) to the diameter of the materials of the layer (3), in particular the coal and the polymer superabsorbent (5), is from 650:1 to 10:1, or from 500:1 to 20:1, or from 400:1 to 30:1, from 300:1 to 40:1, or from 200:1 to 50:1. In particular, the diameter of the materials of the layer (3), in particular the coal and the polymer superabsorbent (5), are to be viewed as synonymous with their grain size.

In a preferred embodiment of the seed unit (1) according to the invention, the layer (3) contains no guar and no guar derivative.

In a preferred embodiment of the seed unit (1) according to the invention
the seed unit (1) takes the form of a pellet or a pill, preferably wherein the layer (3) completely envelops the seed (2) and/or the layer (3) and the seed (2), optionally with the shell (9) surrounding the layer (3) are/form the pellet/pill;
the seed (2) was subjected to a pelletizing process or a pilling process with the mass of which the layer (3) consists, so that preferably the layer (3) and the seed (2), optionally with the shell (9) surrounding the layer (3) form the pellet or pill.

In a preferred embodiment of the seed unit (1) according to the invention the seed unit (1) contains exactly one seed.

In a preferred embodiment of the seed unit (1) according to the invention, the seed unit (1) consists of at least (in particular precisely) one seed (2), a layer (3), a polymeric superabsorbent (5) and an adhesive of biological origin (4), as well as optionally a shell (9) and other auxiliary materials ((6), (7) and (8)).

As stated above, a further subject of the present invention is a method for producing a seed unit (1) according to the invention with the following steps:
STEP I:
Presenting the crbonl in ground form as part of the layer (3)
   mixing with a polymer superabsorbent (5);
   optionally mixing with nutrients or nutrient elements (6) and/or
   optionally mixing with strengthening agents or strengthening elements (8),
   wherein the optional mixing takes place before transfer to a mixing unit (A) or in the mixing unit (A).
grinding in a grinding apparatus (B);
optional STEP II:
optionally adding at least one type of repellent and/or anti-feeding element (7), preferably several different types of repellent and/or anti-feeding elements (7) previously mixed in a mixing unit (C), to the ground mixture from step I in a mixing unit (D);
STEP III:
Adding the seed (2) and the adhesive of biological origin (3), optionally mixing them before addition, to the mixture from step Il in a pelletizing plant (E), the seed (2) forming the core around which pilling, or pelletizing occurs.

As stated above, a further subject of the present invention is a seed unit (1) covered by a layer of biochar, which can be produced by a method comprising the following steps
STEP I:
Presenting the biochar in ground form as part of the layer (3),
mixing with a polymeric superabsorbent (5) containing >50% by weight of polyacrylate;
optionally, mixing with nutrients or nutrient elements (6) and/or
optionally, mixing with strengthening agents or strengthening elements (8),
wherein the optional mixing takes place before transfer to a mixing unit (A) or in the mixing unit (A).
grinding in a grinding apparatus (B);
optional STEP II:
optionally adding at least one type of repellent and/or anti-feeding element (7), preferably several different types of repellent and/or anti-feeding elements (7) previously mixed in a mixing unit (C), to the ground mixture from step I in a mixing unit (D);
STEP III:
Adding the seed (2) and the adhesive of biological origin (3), optionally mixing them before addition, to the mixture from step Il in a pelletizing/pilling plant (E), the seed (2) forming the core around which pilling, or pelletizing occurs.

### EMBODIMENTS

The invention is illustrated in particular by the following list of embodiments:
A1) Seed unit (1) (in particular in the form of a pellet) comprising at least (in particular precisely) a seed (2), a layer (3), a polymeric superabsorbent (5) and an adhesive of biological origin (4), and optionally a shell (9) and further auxiliary materials, the layer (3) at least partially (in particular completely) enclosing the seed (2), characterized in that
   the layer (3) comprises the adhesive of biological origin (4) and the polymeric superabsorbent (5); and
   the polymeric superabsorbent (5) has a grain size of 50 μm-400 μm, and
   the layer (3) comprises coal (in particular activated carbon, biological coal or biochar),
   wherein preferably the layer (3) consists of at least 50% by weight of coal (in particular activated carbon, biological coal or biochar).

A1a) Seed unit (1) according to embodiment A1), characterized in that the polymeric superabsorbent (5) has a grain size of 50 μm-400 μm, in particular if the polymeric superabsorbent (5) is a polyacrylamide, a crosslinked arylamide/acrylic acid, a polyacrylate or is an acrylamide/acrylic acid copolymer.

A1a) Seed unit (1) according to embodiment A1) in the form of a pellet comprising at least one seed (2), a layer (3), a polymeric superabsorbent (5) and an adhesive of biological origin (4), and optionally a shell (9) and further auxiliary materials, wherein the layer (3) at least partially encloses the seed (2), characterized in that
the polymeric superabsorbent (5) is selected from
   a. a polyacrylamide, a crosslinked arylamide/acrylic acid, a polyacrylate or an acrylamide/acrylic acid copolymer, or
   b. a biological polymeric superabsorbent selected from a cellulose or lignin-based hydrogel or a natural rubber derivative;
the layer (3) comprises coal, selected from activated carbon, biological coal or biochar, and consists of at least 50% by weight of the coal, selected from activated carbon, biological coal or biochar, and
the layer (3) comprises the adhesive of biological origin (4) and the polymeric superabsorbent (5).

In a particularly preferred embodiment of the seed unit (1) according to the invention, it is in the form of a pellet comprising at least one seed (2), a layer (3), a polymeric superabsorbent (5) and an adhesive of biological origin (4), and optionally a shell (9) and other auxiliary materials, the layer (3) at least partially enclosing the seed (2), characterized in that
the polymeric superabsorbent (5) is a polyacrylamide, a cross-linked arylamide/acrylic acid, a polyacrylate or an acrylamide/acrylic acid copolymer,
the layer (3) comprises coal, selected from activated carbon, biological coal or biochar, and consists of at least 50% by weight of the coal, selected from activated carbon, biological coal or biochar,
the layer (3) comprises the adhesive of biological origin (4) and the polymeric superabsorbent (5) and
the polymeric superabsorbent (5) has a grain size of 50 μm-400 μm.

A2) Seed unit (1) according to embodiment A1), characterized in that the coal in the layer (3) is at least 50% by weight, at least 75% by weight, at least 90% by weight, at least 95% by weight % by weight, or at least 99% by weight, of activated carbon, biological coal and/or biochar, preferably activated carbon or biochar,
wherein the coal is preferably ground, and/or where the grain size of the coal is ≤200 μm.

A3) Seed unit (1) according to one of the embodiments A1) or A2), characterized in that the glue of biological origin (4) is a protein-containing glue, preferably a glutin-based glue, a fibrin-based glue, or a glue based on the amino acid DPPA, or a fish glue, particularly preferably a fish glue from cold water fish, wherein the adhesive of biological origin can contain additives such as gum arabic or protein hydrolyzate.

A4) Seed unit (1) according to one of the embodiments A1) to A3), characterized in that
the layer (3) completely encloses the seed (2); and or
the superabsorbent (5) and any additional auxiliary materials are embedded in the layer (3)—in particular as particles, and/or
the adhesive of biological origin (4) is distributed approximately uniformly or homogeneously in the layer (3) and in particular in the oarbon, and/or
if appropriate, the shell (9) encloses the layer (3) completely.

A5) Seed unit (1) according to one of the embodiments A1) to A4), characterized in that any additional auxiliary substances are selected from:
Nutrients or nutrient elements (6);
Repellent- and/or anti-feeding-elements (7); and or
strengthening agents or strengthening elements (8).

A6) Seed unit (1) according to one of the embodiments A1) to A5), characterized in that the polymeric superabsorbent (5)
serves as a water storage and disintegrant element, and/or
is solid or crystalline or solid and crystalline, and/or
is ground and/or
has a grain size of 100 μm-350 μm or 150 μm-300 μm or 175 μm-225 μm.

A7) Seed unit (1) according to one of the embodiments A1) to A6), characterized in that the polymeric superabsorbent (5) is a polyacrylamide or a cross-linked arylamide/acrylic acid, a polyacrylate, an acrylamide/acrylic acid copolymer (possibly cross-linked) or mixtures thereof, preferably is sodium polyacrylate or potassium polyacrylate or acrylamide/acrylic acid copolymer potassium or sodium salt or a cross-linked acrylamide/acrylic acid copolymer potassium or sodium salt, a crosslinked arylamide/acrylic acid in the form of a potassium or sodium salt or mixtures thereof, particularly preferably is potassium polyacrylate or acrylamide/acrylic acid copolymer is potassium salt or a cross-linked acrylamide/acrylic acid copolymer potassium salt or a cross-linked arylamide/acrylic acid in the form of a potassium salt (for example Stockosorb®) or mixtures thereof; wherein the polymeric superabsorbent (5)
serves as a water storage and disintegrating element, and/or
is solid or crystalline or solid and crystalline, and/or
is ground and/or
has a grain size of 100 μm-350 μm or 150 μm-300 μm or 175 μm-225 μm.

A8) Seed unit (1) according to one of the embodiments A1) to A7), characterized in that nutrients or nutrient elements (6) are included in the seed unit (1) as a further auxiliary substance and are preferably embedded in the layer (3), whereby the nutrients or nutrient elements (6) are preferably macro- and micronutrients and/or nutrients or nutrient elements (6) on an organic basis, wherein these are preferably protein-based fertilizers, preferably vinasse/stillage or protein hydrolysates.

A9) Seed unit (1) according to one of the embodiments A1) to A8), characterized in that repellent- and/or anti-feeding-elements (7) are included in the seed unit (1) as a further auxiliary substance and are preferably embedded in the layer (3), wherein the repellent- and/or anti-feeding-elements (7) are preferably based on plant and/or aromatic extracts, optionally based on ethereal plant and/or aromatic extracts, in particular including extracts of cayenne pepper, neem tree ginger, oregano, geraniums, cistus or thyme.

A10) Seed unit (1) according to one of the embodiments A1) to A9), characterized in that strengthening agent or strengthening elements (8) are included in the seed unit (1) as a further auxiliary substance and are preferably embedded in the layer (3), wherein the strengthening elements (8) preferably comprise organic fertilizers, preferably a strengthening agent obtained from pitch clove and lupine.

A11) Seed unit (1) according to one of the embodiments A1) to A10), characterized in that the seed unit (1) also comprises a shell (9), the shell (9) preferably completely enclosing the layer (3), the shell (9) preferably consisting of gelatin, cellulose, carrageenan, starch or glue.

A12) Seed unit (1) according to one of the embodiments A1) to A11), characterized in that the seed (2) is a small-grain seed (2), in particular a seed (2) with a size <3.5 mm, preferably the seed (2) is selected from seeds for carrots, salads, tomatoes, sugar beets, fodder beets, rapeseed, camelina, flax, cabbage, beetroot, radish, parsnip, celery, parsley, chives, or medicinal herbs such as valerian, thyme, oregano, ribwort plantain, coneflower.

A13) Seed unit (1) according to one of the embodiments A1) to A12), characterized in that
the layer (3) consists of 5-30% by weight or 10-20% by weight of the polymeric superabsorbent (5);
   preferably
the layer (3) consists of 1-15% by weight of the adhesive of biological origin;
the layer (3) consists of 5-30 (preferably 10-20) % by weight of the polymeric superabsorbent (5), and
the layer (3) consists of 55-94% by weight of coal;
   in particular
the layer (3) consists of 1-15% by weight of the adhesive of biological origin;
the layer (3) consists of 5-30 (preferably 10-20) % by weight of the polymeric superabsorbent (5), and/or
the layer (3) consists of 1-20 (preferably 5-15) % by weight of nutrients or nutrient elements (6) when optionally added,
the layer (3) consists of 1-10% by weight of repellent- and/or anti-feeding-elements (7) when optionally added,
the layer (3) consists of 0.001-1% by weight of strengthening agents or strengthening elements (8) when optionally added,
the rest of the layer (3) consists of coal.

A14) Method for producing a seed unit (1) according to one of the embodiments A1) to A13), with the following steps:
STEP I:
Presenting the coal in ground form as part of the layer (3)
   mixing with a polymer superabsorbent (5);
   optionally mixing with nutrients or nutrient elements (6) and/or
   optionally mixing with strengthening agents or strengthening elements (8),
   wherein the optional mixing takes place before transfer to a mixing unit (A) or in the mixing unit (A).
grinding in a grinding apparatus (B);
Optional STEP II:
Optionally adding at least one type of repellent- and/or anti-feeding-element (7), preferably several different types of repellent- and/or anti-feeding-elements (7) previously mixed in a mixing unit (C),
to the ground mixture from step I in a mixing unit (D);
STEP III:
Adding the seed (2) and the adhesive of biological origin (3), optionally mixing them before addition, to the mixture from step II in a pelletizing plant (E), the seed (2) forming the core around which pilling or pelletizing occurs.

A15) Seed unit (1) covered by a layer of biochar, producible by a process comprising the following steps
STEP I:
Presenting the biochar in ground form as part of the layer (3),
mixing with a polymeric superabsorbent (5) containing ≥50% by weight of polyacrylate;
optionally mixing with nutrients or nutrient elements (6) and/or
optionally mixing with strengthening agents or strengthening elements (8),
wherein the optional mixing takes place before transfer to a mixing unit (A) or in the mixing unit (A).
grinding in a grinding apparatus (B);
optional STEP II:
Optionally adding at least one type of repellent- and/or anti-feeding-element (7), preferably several different types of repellent- and/or anti-feeding-elements (7) previously mixed in a mixing unit (C),
to the ground mixture from step I in a mixing unit (D);
STEP III:
Adding the seed (2) and the adhesive of biological origin (3), optionally mixing them before addition, to the mixture from step Il in a pelletizing plant (E), the seed (2) forming the core around which pilling, or pelletizing occurs.

A16) Seed unit (1) according to one of the embodiments A1) to A13), characterized in that the layer (3) contains no guar and no guar derivative.

A17) Seed unit (1) according to one of the embodiments A1) to A13) and A16), characterized in that
the seed unit (1) takes the form of a pellet or a pill, preferably the layer (3) completely enveloping the seed (2) and/or the layer (3) and the seed (2), optionally with the shell (9) which surrounds the layer (3) being/forming the pellet/pill;
the seed (2) was subjected to a pelletizing process or a pilling process with the mass of which the layer (3) consists, so that preferably the layer (3) and the seed (2), optionally with the shell (9) which surrounds the layer (3) forming the pellet or pill.

A18) Seed unit (1) according to one of the embodiments A1) to A13), A16) and A17), characterized in that the seed unit (1) contains exactly one seed.

A19) Seed unit (1) (in particular in the form of a pellet) according to one of the embodiments A1) to A13) and A16) to A18), characterized in that the seed unit (1) consists of at least (in particular of exactly) one seed (2), a layer (3), a polymeric superabsorbent (5) and an adhesive of biological origin (4), as well as optionally a shell (9) and other auxiliary materials ((6), (7) and (8)).

### EXAMPLES

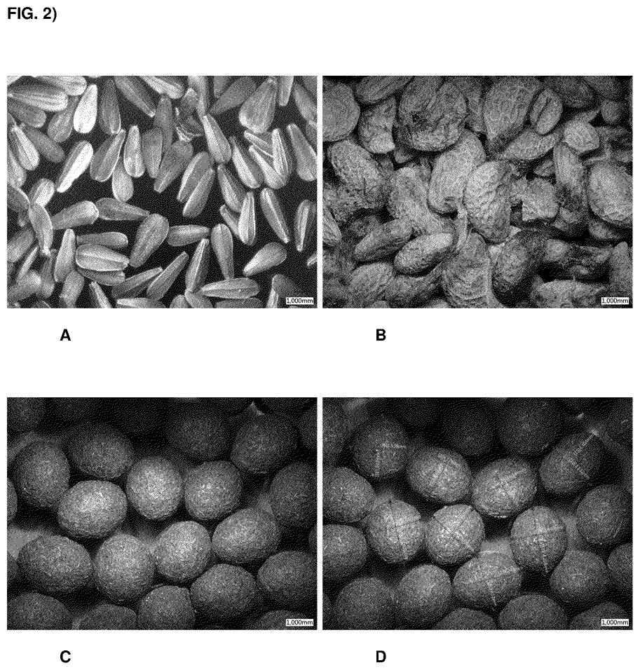

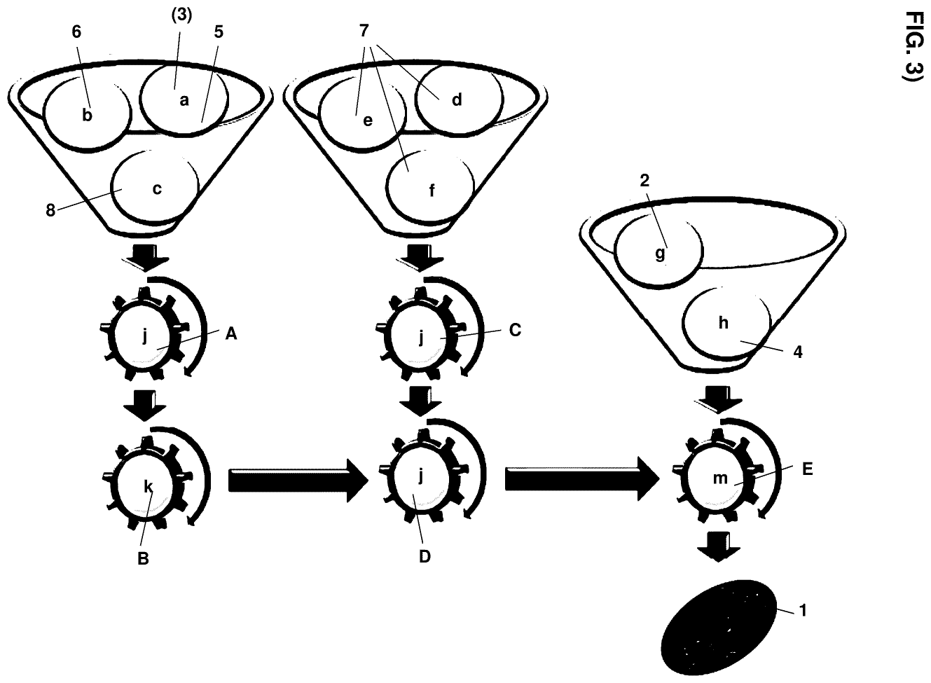

FIG. 2) shows the results of the pelleting of various seeds, namely valerian seeds (A) and raspberry seeds (B), using the method according to the invention (see also FIG. 3), so that seed units according to the invention were created in the form of pellets (C) or (D).

### REFERENCE SYMBOL LIST FOR FIGURE FIG. 3

(1) Seed unit
(2) Seed
(3) Layer (coal)
(4) Glue of biological origin
(5) Polymeric superabsorbent
(6) Nutrient
(7) Repellent and anti-feeding element
(8) Strengthening agent
(A) Mixing unit
(B) Grinding apparatus
(C) Mixing unit
(D) Mixing unit
(E) Pilling plant

Optionally, the following letters represent the following information:
(a) Biochar 70% m/m+potassium polyacrylate 19.998% m/m
(b) Organic fertilizer 10% m/m
(c) Plant strengthening agent 0.002% m/m
(d) Neem oil 15% m/m
(e) Cayenne pepper extract 4% m/m
(f) Thyme essential oil 1% m/m
(g) Seeds
(h) Pilling aid (binder)
(j) Mixing unit
(k) Grinding
(m) Pilling plant.

1. Seed unit (1) in the form of a pellet comprising at least one seed (2) and a layer (3) comprising coal, selected from activated carbon, biological coal or biochar, a polymeric superabsorbent (5) and an adhesive of biological origin (4); and optionally a shell (9) and further auxiliary materials, the layer (3) at least partially enclosing the seed (2), characterized in that
the polymeric superabsorbent (5) is selected from
a. a polyacrylamide, a crosslinked arylamide/acrylic acid, a polyacrylate or an acrylamide/acrylic acid copolymer and is granular, or
b. a biological polymeric superabsorbent selected from a cellulose- or lignin-based hydrogel or a natural rubber derivative;
the layer (3) consists of at least 50% by weight of coal, selected from activated carbon, biological coal or biochar.

2. Seed unit (1) according to claim 1 in the form of a pellet comprising at least one seed (2) and a layer (3) comprising coal, selected from activated carbon, biological coal or biochar, a granular polymeric superabsorbent (5) and an adhesive of biological origin (4); and optionally a shell (9) and further auxiliary materials, the layer (3) at least partially enclosing the seed (2), characterized in that
the polymeric superabsorbent (5) is a polyacrylamide, a cross-linked arylamide/acrylic acid, a polyacrylate or an acrylamide/acrylic acid copolymer,
the layer (3) consists of at least 50% by weight of the coal, selected from activated carbon, biological coal or biochar, and
the polymeric superabsorbent (5) has a grain size of 50 μm-400 μm.

3. Seed unit (1) according to one of claims 1 or 2, characterized in that the layer (3)
consists of at least 60% by weight, at least 70% by weight, at least 95% by weight, or at least 99% by weight of biochar, the biochar preferably being ground, and/or wherein the grain size of the biochar is ≤200 μm, 30 μm-200 μm, or 40 μm-200 μm, or 30 μm-180 μm, or 50 μm-150 μm, or 80 μm-120 μm.

4. Seed unit (1) according to one of claims 1 to 3, characterized in that the adhesive of biological origin (4) is a protein-containing adhesive, preferably a glutin-based adhesive, a fibrin-based adhesive, or an adhesive based on the amino acid DPPA, or fish glue, particularly preferably fish glue from cold water fish, wherein the glue of biological origin can contain additives such as gum arabic or protein hydrolyzate.

5. Seed unit (1) according to one of claims 1 to 4, characterized in that the optionally further auxiliary substances are selected from:
Nutrients or nutrient elements (6);
Repellent- and/or anti-feeding-elements; and/or
Strengthening agents or strengthening elements (8).

6. Seed unit (1) according to one of claims 1 to 4,
a) characterized in that the polymeric superabsorbent (5) is granular and is a polyacrylamide, a crosslinked arylamide/acrylic acid, a polyacrylate or an acrylamide/acrylic acid copolymer; in particular is a sodium polyacrylate or potassium polyacrylate or acrylamide/acrylic acid copolymer potassium or sodium salt or a cross-linked acrylamide/acrylic acid copolymer potassium or sodium salt, a cross-linked arylamide/acrylic acid in the form of a potassium or sodium salt or mixtures thereof; particularly preferably is potassium polyacrylate or acrylamide/acrylic acid copolymer potassium salt or a cross-linked acrylamide/acrylic acid copolymer potassium salt or a crosslinked arylamide/acrylic acid in the form of a potassium salt or mixtures thereof, the polymeric superabsorbent (5).
serves as a water storage and disintegrating element, and/or
is solid or crystalline or solid and crystalline, and/or
is ground and/or
has a grain size of 50 μm-400 μm, or 100 μm-350 μm, or 150 μm-300 μm, or 175 μm-225 μm, or a grain size of 30 μm-180, 50 μm-200 μm, or of 50 μm-150 μm or from 80 μm-120 μm;
or
b) characterized in that the polymeric superabsorbent (5) is a biological polymeric superabsorbent, selected from a cellulose or lignin-based hydrogel or a natural rubber derivative, preferably selected from a cellulose or lignin-based hydrogel, in particular selected from Polyter GT or Agrobiogel.

7. Seed unit (1) according to one of claims 1 to 5, characterized in that nutrients or nutrient elements (6) are included in the seed unit (1) as a further auxiliary substance and are preferably embedded in the layer (3), wherein the nutrients or nutrient elements (6) are preferably macro- and micronutrients and/or nutrients or nutrient elements (6) on an organic basis, wherein these preferably being protein-based fertilizers, preferably vinasse/stillage or protein hydrolysates.

8. Seed unit (1) according to one of claims 1 to 6, characterized in that as a further auxiliary agent repellent- and/or anti-feeding-elements (7) are included in the seed unit (1) and are preferably embedded in the layer (3); wherein the repellent- and/or anti-feeding-elements (7) are preferably based on plant and/or aromatic extracts, optionally based on ethereal plant and/or aromatic extracts, in particular including extracts of cayenne pepper, neem tree ginger, oregano, geraniums, cistus or thyme.

9. Seed unit (1) according to one of claims 1 to 7, characterized in that strengthening agent or strengthening elements (8) are included in the seed unit (1) as a further auxiliary substance and are preferably embedded in the layer (3), whereby the strengthening elements (8) preferably comprise organic fertilizers, preferably a strengthening agent obtained from pitch clove and lupine;
and/or
characterized in that the seed (2) is a small-grain seed (2), in particular a seed (2) with a size of <3.5 mm, preferably the seed (2) is selected from seeds for carrots, salads, tomatoes, sugar beet, fodder beet, rapeseed, camelina, flax, cabbage, beetroot, radish, parsnip, celery, parsley, chives, or medicinal herbs such as valerian, thyme, oregano, ribwort plantain, coneflower.

10. Seed unit (1) according to one of claims 1 to 9, characterized in that
the layer (3) consists of 5-30% by weight or 10-20% by weight of the polymeric superabsorbent (5);
preferably
the layer (3) consists of 1-15% by weight of the adhesive of biological origin;
the layer (3) consists of 5-30% by weight of the polymeric superabsorbent (5), and
the layer (3) consists of 55-94% by weight of coal;
in particular
the layer (3) consists of 1-15% by weight of the adhesive of biological origin;
the layer (3) consists of 5-30% by weight of the polymeric superabsorbent (5), and/or
the layer (3) consists of 1-20% by weight of nutrients or nutrient elements (6) when optionally added,
the layer (3) consists of 1-10% by weight of repellent and/or anti-feeding elements (7) when optionally added,
the layer (3) consists of 0.001-1% by weight of strengthening agents or strengthening elements (8) when optionally added,
the rest of the layer (3) consists of coal.

11. Seed unit (1) according to one of claims 1 to 10, characterized in that the ratio of the diameter of the seed unit (1) to the diameter of the materials of the layer (3), in particular the coal and the polymeric superabsorbent (5), is from 650:1 to 10:1, or from 500:1 to 20:1, or from 400:1 to 30:1, from 300:1 to 40:1, or from 200:1 to 50:1.
